(19) United States
(12) Patent Application Publication
(10) Pub. No.: US 2014/0329016 A1
(43) Pub. Date: Nov. 6, 2014

(54) Coating Method for Objects of Extended Size

(71) Applicant: The Lund Industrial Group, Holly Springs, MS (US)

(72) Inventor: Earl E. Hill, Rossville, TN (US)

(73) Assignee: THE LUND INDUSTRIAL GROUP, Holly Springs, MS (US)

(21) Appl. No.: 14/173,009

(22) Filed: Feb. 5, 2014

Related U.S. Application Data
(60) Provisional application No. 61/818,276, filed on May 1, 2013.

(51) Int. Cl. B05D 3/02; B05D 5/00; C23C 26/00; H05B 6/06; H05B 6/10

(52) U.S. Cl. CPC B05D 3/0281; H05B 6/06; H05B 6/10; C23C 26/00; B05D 5/00
USPC 427/327; 219/667; 219/600

(57) ABSTRACT

This invention discloses a metal coating method whereby an abrasion resistant and wear resistant coating is first applied to the that portion of a metal object of extended size to be protected, the coating is then fused onto the metal object with the use of a temperature controlled induction heater, which results in a metal object, at least a portion of which is more abrasion resistant and wear resistant than the uncoated metal object.

### CROSS-REFERENCE TO RELATED APPLICATIONS

| | | |
|---|---|---|
| 7,631,702 | December, 2009 | Hansen |
| 6,264,886 | July 2001 | Mizuta |
| 61/818,276 | May, 2013 | Hill |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### FIELD OF THE INVENTION

This invention discloses a metal coating method of applying an abrasion resistant and wear resistant coating on that portion of a metal object of extended size that will be exposed to abrasive materials, then fusing the coating onto the metal object to produce a durable metal object of extended size that is more abrasion resistant and wear resistant than the original.

### BACKGROUND OF THE INVENTION

Metal objects of extended size such as augers are used in the agricultural, construction and material handling industries to breakup soil and other materials and to transport materials from one location to another. Over the operational life of these metal objects, they are exposed to abrasive conditions that cause the metal objects to wear out. Attempts have been made to extend the life of said metal objects by affixing abrasive resistant and wear resistant coatings onto them, which would then decrease maintenance downtime and replacement costs. However, pasted on abrasive resistant and wear resistant coatings scrape off during use of the metal objects. The present disclosure teaches a method of fusing an abrasive resistant and wear resistant coating to a portion of a metal object of extended side.

In U.S. Pat. No. 7,631,702 Hansen claims a fused hard-faced double coated rotary tempered metal harrow disk blade, whereas the present disclosure reveals the method for fusing an abrasive resistant and wear resistant coating onto a portion or all of a metal of extended size with the use of a temperature controlled induction heater.

In U.S. Pat. No. 6,264,886 Mizuta teaches a method of fusing metallic powder into a solid predetermined shape by filling a mold with the metallic powder and then heating the mold and powder until the metallic powder fuses together, whereas the present disclosure reveals a method of fusing a metallic coating onto a metal object of extended size without a mold.

In U.S. Provisional Patent Application 61/818,276 Hill teaches wear coating and method of application to auger flighting.

### SUMMARY OF THE INVENTION

A method of applying an abrasive resistant and wear resistant coating to that portion of a metal object of extended size that will be exposed to abrasive materials, where the metal object is first cleaned to remove rust, dirt and other foreign material from the surface of the metal object, followed by the application of the abrasive resistant and wear resistant coating to that portion of the metal object that will be exposed to abrasives when in use, and then fusing the abrasive resistant and wear coating to the metal object with the use of a temperature controlled induction heater or a climate controlled sintering furnace.

In a preferred embodiment of the disclosure, the outer portion of the flighting of an auger is coated with an abrasive resistant and wear resistant coating. The auger is then rotated and moved past the temperature controlled induction heater to fuse the abrasive resistant and wear resistant coating to the metal object.

### BRIEF DESCRIPTION OF THE SEVERAL VIEWS OF THE DRAWING

FIG. 1 is a one-line drawing of the method of coating a metal object using a temperature controlled induction heater to fuse the coating to the metal object;

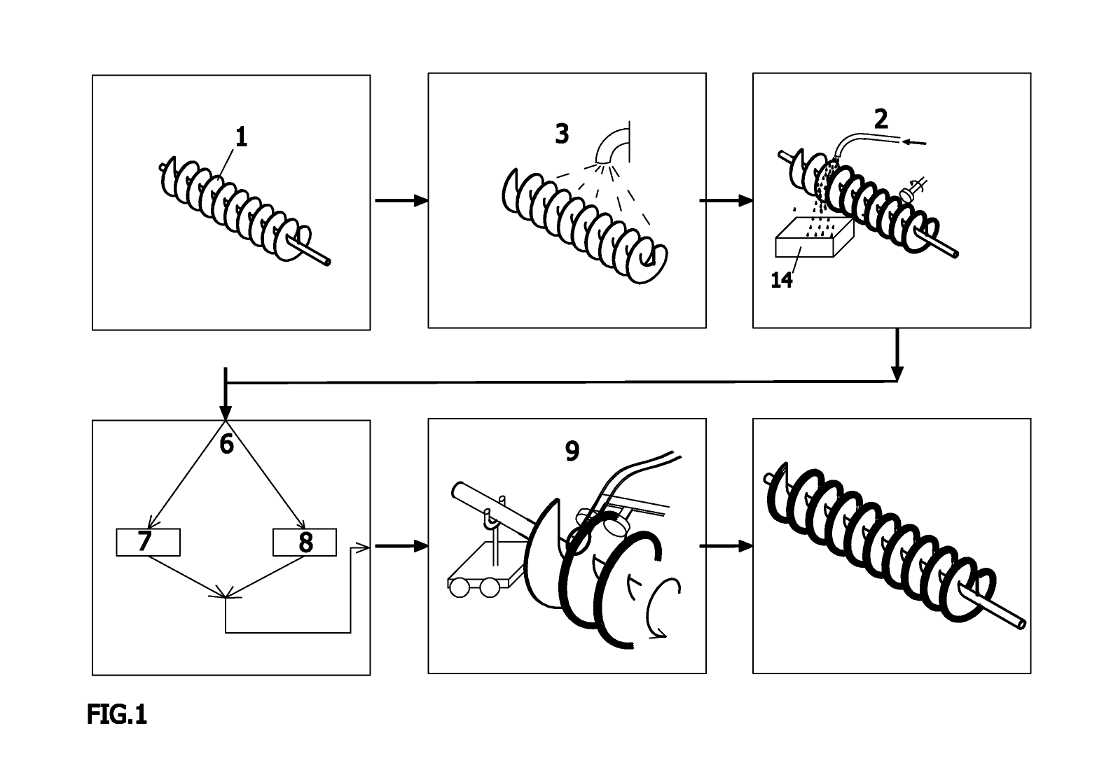

FIG. 2 is a drawing of a preferred embodiment of the coating process that involves pouring the coating onto the metal object and collecting the excess in a vat;

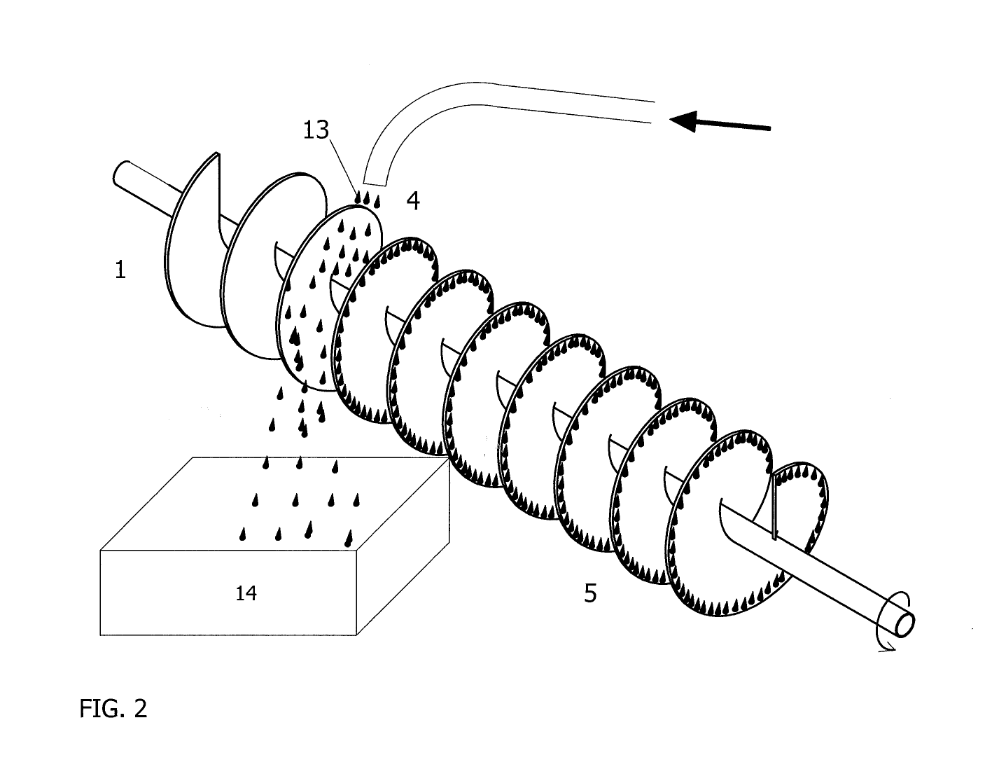

FIG. 3 is a drawing of the temperature controlled induction heater including the induction heater, temperature probe and an arm that prevents the induction heater from coming into contact with the metal object as the metal object is being heated; and

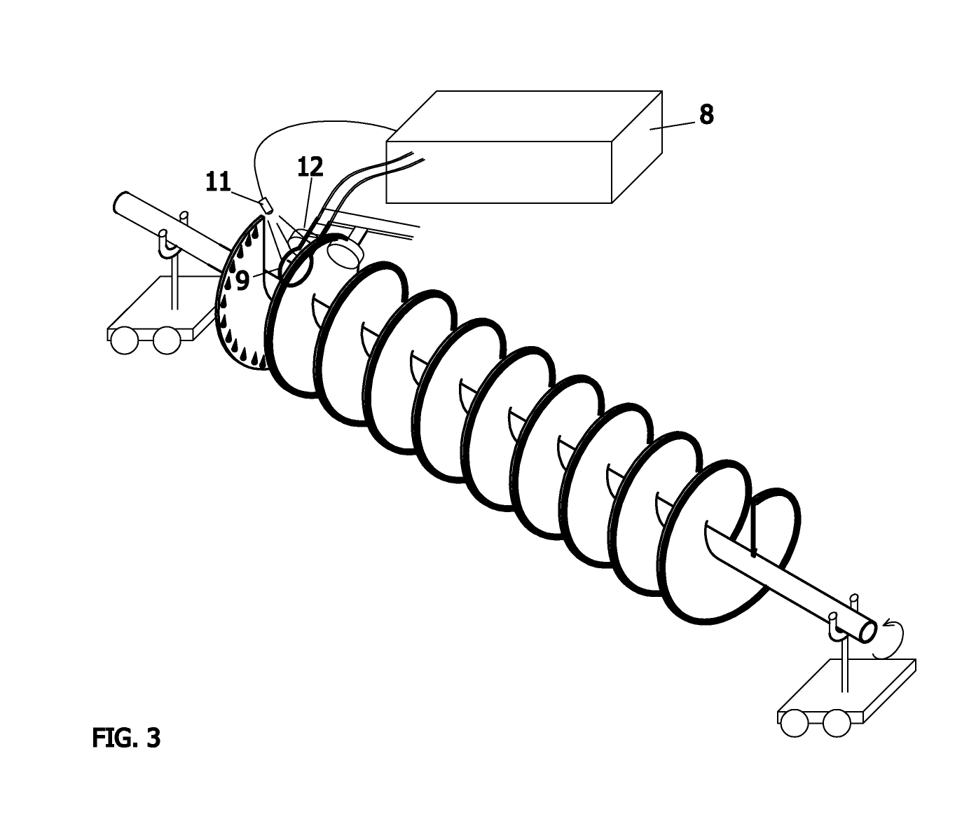

### DETAILED DESCRIPTION OF THE INVENTION

A method of fusing an abrasive resistant and wear resistant coating onto a metal object of extended size 1 that results in a durable metal object of extended size 2 that is more resistant to abrasion and wear comprising first a means of cleaning 3 the metal object 1, then a means of coating 4 that portion of the metal object 1 to be protected with an abrasive resistant and wear resistant coating 13 to produce a coated metal object 5. A means for drying 6 the coating on the coated metal object 5 is then used, which may include such methods as air drying 7 or inserting the coated metal object into a drying oven 8. Once the abrasive resistant and wear resistant coating has dried, a conveyor means passes the coated metal object 5 by a temperature controlled induction heater 9 to fuse the coating to the metal object 1, to produce the durable metal object of extended size 2. The temperature controlled induction heater 9 comprises an induction heater 10 and a temperature probe means 11. The temperature probe means 11 detects the temperature of the coated metal object 5 at the location where the induction heater 10 is being applied. Using a predetermined range of acceptable temperatures the temperature probe means 11 feeds information to a control means to adjust the rate the conveyer means passes the coated metal object 5 past the induction heater 10 and/or to regulate the amount of current going to the induction heater 10 in order to control how hot the coated metal object 5 becomes as it passes by the induction heater 10.

In one preferred embodiment for the application of the abrasive resistant and wear resistant coating 13, the abrasive resistant and wear resistant coating 13 is applied by means of pouring the abrasive resistant and wear resistant coating 13 on to the metal object 1, by conveying the metal object 1 past the flow of the abrasive resistant and wear resistant coating 13, and collecting the excess coating in a vat 14 for reuse, which results in a coated metal object 5 that has an abrasive resistant and wear resistant coating 13 with a relatively consistent thickness across the entire coated surface.

In one preferred embodiment for fusing, the temperature probe means 11 and the control means control the temperature that the coated metal object 5 attains by adjusting the rate the conveyor means moves the coated metal object 5 past the induction heater 10.

In a second preferred embodiment for fusing, the temperature probe means 11 and the control means regulate the temperature the coated metal object 5 attains by having the control means adjust the amount of current being fed to the induction heater 10.

In a third preferred embodiment, the temperature probe means 11 and the control means regulate the temperature the coated metal object 5 attains by adjusting the rate the conveyor means moves the coated metal object 5 past the induction heater 10 and by adjusting the amount of current being fed to the induction heater 10.

An additional means 12 may also be used to establish a minimum distance between the induction heater 10 and the coated metal object 5 to ensure the induction heater 10 never comes in contact with the coated metal object 5.

In a another preferred embodiment, the temperature controlled induction heater 8 is replaced by a climate controlled sintering furnace whereby, after the coating 13 on the metal object 1 has dried, the coated metal object 5 is inserted into the climate controlled sintering furnace to heat the coated metal object 5 until the coating 13 is fused to the metal object 1, to produce a durable metal object of extended size 2.

What is claimed:

1. A method of increasing the durability of a metal object of extended size by applying an abrasion resistant and wear resistant coating onto that a portion of, or the entire, metal object's surface, said method comprising:
a means of cleaning the metal object to remove dirt, rust and other foreign material;
a means of coating the metal object by applying said abrasion resistant and wear resistant coating onto that portion of the metal object that is to be treated;
a means of drying said abrasion resistant and wear resistant coating that has been applied to the metal object;
fusing the abrasion resistant and wear resistant coating to the metal object with the use of a temperature controlled induction heater; and
tempering the coated metal object to ensure proper hardness.

2. The fusing process of claim 1 where temperature controlled induction heater is stationary and the coated metal object is moved past the temperature controlled induction heater by a conveyor means.

3. The temperature controlled induction heater of claim 2 comprising an induction heater and a temperature probe where the temperature probe constantly monitors the temperature of the metal object and the coating that is being fused to the metal object such that the temperature sensor feeds data to a control means that adjusts the rate at which the coated metal object is conveyed past the induction heater.

4. The temperature controlled induction heater of claim 2 comprising an induction heater and a temperature probe where the temperature probe constantly monitors the temperature of the metal object and the coating that is being fused to the metal object such that the temperature sensor feeds data to a control means that regulates the amount of current being sent to the induction heater.

5. The temperature controlled induction heater of claim 2 comprising an induction heater and a temperature probe where the temperature probe constantly monitors the temperature of the metal object and the coating that is being fused to the metal object such that the temperature sensor feeds data to a control means that regulates both the rate at which the metal object is conveyed past the induction heater and the amount of current being sent to the induction heater.

6. The temperature controlled induction heater of claim 3, 4 or 5 additionally comprising a means to insure a minimum distance between the induction heater and the metal object so that the induction heater never comes in to contact with the metal object.

7. A method of increasing the durability of a metal object of extended size by applying an abrasion resistant and wear resistant coating onto that a portion of, or the entire, metal object's surface, said method comprising:
a means of cleaning the metal object to remove dirt, rust and other foreign material;
a means of coating the metal object by applying said abrasion resistant and wear resistant coating onto that portion of the metal object that is to be treated;
a means of drying said abrasion resistant and wear resistant coating that has been applied to the metal object;
fusing the abrasion resistant and wear resistant coating to the metal object with the use of a climate controlled sintering furnace; and
tempering the coated metal object to ensure proper hardness.
